(19) United States
(12) Patent Application Publication
(10) Pub. No.: US 2013/0154276 A1
(43) Pub. Date: Jun. 20, 2013

(54) INTEGRATED HEIGHT SENSOR AND REGENERATIVE ENERGY GENERATION DEVICE

(71) Applicant: Sung Yong Lee, Hwaseong (KR)

(72) Inventor: Sung Yong Lee, Hwaseong (KR)

(73) Assignee: HYUNDAI MOTOR COMPANY, Seoul (KR)

(21) Appl. No.: 13/472,649

(22) Filed: May 16, 2012

(30) Foreign Application Priority Data
Dec. 14, 2011 (KR) 10-2011-0134802

(51) Int. Cl. H02K 7/18; H02K 7/116

(52) U.S. Cl. 290/1 C; 290/1 R

(57) ABSTRACT

A regenerative energy generation device is provided, which includes a height sensor fixed to a vehicle by a bracket, a lever portion rotatably installed on the height sensor at a predetermined angle to be rotated as a height between the vehicle and the ground is changed, and a generator rotated by the rotation of the lever portion to generate energy.

### CROSS-REFERENCE TO RELATED APPLICATION

This application is based on and claims priority from Korean Patent Application No. 10-2011-0134802, filed on Dec. 14, 2011 in the Korean Intellectual Property Office, the disclosure of which is incorporated herein in its entirety by reference.

### BACKGROUND OF THE INVENTION

1. Field of the Invention

The present invention relates to a regenerative energy generation device, and more particularly to a height sensor integration type regenerative energy generation device.

2. Description of the Prior Art

Vehicle manufactures have begun to use height sensors to sense the distance between the ground and a vehicle's body to determine the vehicle's height off the ground, which changes depending upon load that the vehicle is currently carrying.

This type of height sensor is typically fixed to a lower portion of the vehicle and is coupled to a connection device. The connection device includes a lever rotatably coupled to the sensor at a predetermined angle, a rod coupled to an end portion of the lever, and a coupling member having one side coupled to the holder and the other side fixed to a wheel and a wheel shaft connecting the wheel.

However, these conventional height sensor configurations are unable to reuse kinetic energy that is generated when the vehicle moves up and down as a source of power.

### SUMMARY OF THE INVENTION

Accordingly, the present invention has been made to solve the above-mentioned problems occurring in the related art while advantages achieved by the related art are maintained intact.

The present invention provides a regenerative energy generation device, which effectively uses kinetic energy generated when the vehicle moves up and down to power devices within the vehicle through integration of a height sensor and the regenerative energy generation device.

In one aspect of the present invention, there is provided a regenerative energy generation device, which includes a height sensor fixed to a vehicle via a bracket; a lever portion rotatably installed on the height sensor at a predetermined angle to be rotated as a height between the vehicle and the ground is changed; and a generator rotated by the rotation of the lever portion to generate energy when the height between the vehicle and the ground is changed.

According to the present invention, by integrating the height sensor and the regenerative energy generation device, it is possible to sense the vehicle height and to reuse the kinetic energy that is generated during the vertical movement of the vehicle to improve the energy efficiency and the fuel efficiency.

### BRIEF DESCRIPTION OF THE DRAWINGS

The above and other objects, features and advantages of the present invention will be more apparent from the following detailed description taken in conjunction with the accompanying drawings, in which:

FIG. 1 is a front perspective view illustrating a regenerative energy generation device according to an exemplary embodiment of the present invention;

FIG. 2 is a rear perspective view illustrating a regenerative energy generation device according to an exemplary embodiment of the present invention; and

FIG. 3 is a side view illustrating a regenerative energy generation device according to an exemplary embodiment of the present invention.

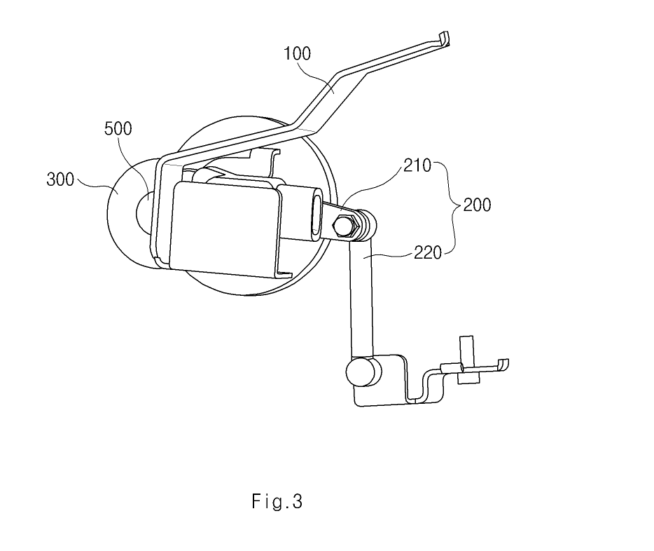

### DETAILED DESCRIPTION OF THE PREFERRED EMBODIMENTS

Hereinafter, a preferred embodiment of the present invention will be described with reference to the accompanying drawing. The matters defined in the description, such as the detailed construction and elements, are nothing but specific details provided to assist those of ordinary skill in the art in a comprehensive understanding of the invention, and thus the present invention is not limited thereto. In the drawings, portions that do not relate to the description of the present invention are omitted. In the entire description of the present invention, the similar drawing reference numerals are used for the similar elements across various figures.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

A regenerative energy generation device according to an embodiment of the present invention provides a configuration that decreases the manufacturing cost and increases the utility of “vanishing” kinetic energy through integration of a height sensor and the regenerative energy generation device as one unit.

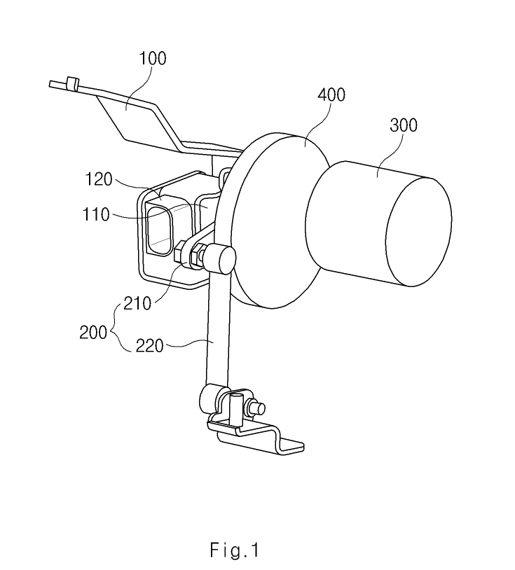

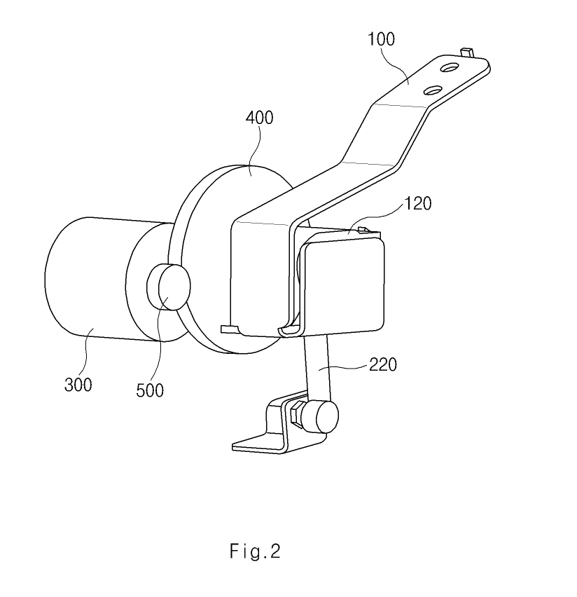

The regenerative energy generation device, as illustrated in FIGS. 1 and 2, includes a height sensor 100 fixed to a vehicle by a bracket 110 that is fixed to a vehicle body to calculate the changing height between the vehicle and the ground, a lever portion 200 rotatably installed on the height sensor 100 at a predetermined angle to transfer a rotational force to the height sensor 100 as the height between the vehicle and the ground is changed, and a generator 300 that is rotated by the rotation of the lever portion 200 to generate energy when the height of the vehicle is changed. In this exemplary embodiment of the present invention, the height sensor 100 is mounted on a sensor housing 120 disposed within in the bracket 110 to protect the height sensor 100 from external impact.

Further, the lever portion 200 includes a lever 210 rotatably coupled to one side of the height sensor 100 at a predetermined angle, and a rod 220 having one end connected to the lever 210 and the other end coupled to a component that moves with the vehicle as the vehicle moves up and down on the wheel side of the device.

That is, if the height between the vehicle and the ground is changed, the rod 220 moves upward and downward accordingly, and the lever 210 is rotated upward and downward by the rod 220 as a result. At this time, the rotating force of the lever 210 is transferred to the height sensor 100, and the height sensor 100 calculates the height of the vehicle on the basis of the height difference that is caused by the rotation.

Additionally, the rotating energy of the lever 210 is transferred to the generator 300 to be stored as energy, and the energy stored in the generator 300 is used when a vehicle interior device is operated. Here, the hinge shaft of the lever 210 and the rotating shaft of the generator 300 are connected to transfer power via a one-way clutch 400. The one-way clutch 400 serves to transfer the rotating force only in one direction to the generator 300 when the lever 210 is rotated upward and downward.

In some embodiments of the present invention, the one-way clutch 400 and the rotating shaft of the generator are connected to transfer power by a speed reducer 500. In this case, the rotating force of the one-way clutch 400 transferred to the generator 300 is reduced by the speed reducer 500 to an amount dictated by the constraints of the speed reducer 500.

As described above, according to the regenerative energy generation device according to the present invention, the vehicle height is calculated by the height sensor 100 and the rotating energy that is generated depending on the change of the vehicle height is reused to improve the energy efficiency.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A regenerative energy generation device comprising:
a height sensor fixed to a vehicle via a bracket;
a lever portion rotatably installed on the height sensor at a predetermined angle to be rotated as a height between the vehicle and the ground is changed; and
a generator rotated by the rotation of the lever portion to generate energy as the height between the vehicle and the ground is changed.

2. The regenerative energy generation device according to claim 1, wherein the lever portion comprises:
a lever rotatably coupled to one side of the height sensor at the predetermined angle; and
a rod having one end connected to the lever and the other end coupled a part that moves with the vehicle as the vehicle changes height

3. The regenerative energy generation device according to claim 1, wherein a one-way clutch is mounted between the generator and the height sensor to transfer a rotating force to the generator in one direction when the lever portion is rotated.

4. The regenerative energy generation device according to claim 3, wherein a speed reducer is mounted between the generator and the one-way clutch to reduce the rotating force that is transferred from the one-way clutch to the generator.
